(19) United States
(12) Patent Application Publication
(10) Pub. No.: US 2025/0258630 A1
(43) Pub. Date: Aug. 14, 2025

(54) ELECTRONIC DEVICE, METHOD, AND STORAGE MEDIUM

(71) Applicant: Toshiba Tec Kabushiki Kaisha, Tokyo (JP)

(72) Inventors: Jun Jit MOEY, Singapore (SG); Hiroyuki INABA, Izunokuni Shizuoka (JP)

(21) Appl. No.: 18/934,131

(22) Filed: Oct. 31, 2024

(30) Foreign Application Priority Data
Feb. 9, 2024 (JP) 2024-018798

(51) Int. Cl. G06F 3/12

(52) U.S. Cl. CPC G06F 3/1209; G06F 3/1231

(57) ABSTRACT

An electronic device connectable to a host device includes a housing including a cover, a connector, a button on an outer surface of the housing, a sensor attached to the cover, a storage device that stores first information indicating a plurality of protocols each for establishing communication with a device of a different device class, and a processor configured to perform a process of establishing communication with a host device connected to the connector using one of the protocols, and change said one of the protocols to another protocol to communicate with the host device upon receipt of an input operation through the button and a first signal from the sensor in a predetermined order.

### CROSS-REFERENCE TO RELATED APPLICATION(S)

This application is based upon and claims the benefit of priority from Japanese Patent Application No. 2024-018798, filed Feb. 9, 2024, the entire contents of which are incorporated herein by reference.

### FIELD

Embodiments described herein relate generally to an electronic device, a method, and a storage medium.

### BACKGROUND

Various electronic devices (or Universal Serial Bus (USB) devices) are connected via USB connectors to a host device, such as a Personal Computer (PC) or a Point-Of-Sale (POS) terminal. For example, a printer device, such as a thermal printer, is connected to a POS terminal.

A device driver corresponding to the device class of a connected USB device is installed in the host device so that the USB device can be used as a peripheral device. Specifically, a process, which is called enumeration, for establishing communication is performed between the host device and the USB device to enable the host device to use the USB device. Here, a printer device, such as a thermal printer, may have a simple configuration in which operation interfaces, such as operation buttons, are omitted as much as possible to reduce, for example, the size and costs of the printer device.

Meanwhile, there are cases where device drivers installable in a host device are limited for various reasons. For example, when device drivers of the host device do not match the device class indicating the type of a USB device to be connected, the host device cannot use the USB device.

Certain USB devices are configured such that a device class can be manually selected from multiple device classes and can operate in the selected device class. However, with a printer device having a simple configuration as described above, the device class cannot be easily changed, and the printer device needs to be improved in terms of user convenience.

### SUMMARY OF THE INVENTION

An aspect of the present disclosure provides an electronic device, a method, and a storage medium that makes it more convenient to change device classes.

An aspect of the present disclosure provides an electronic device connectable to a host device, comprising: a housing including a cover; a connector; a button on an outer surface of the housing; a sensor attached to the cover; a storage device that stores first information indicating a plurality of protocols each for establishing communication with a device of a different device class; and a processor configured to: perform a process of establishing communication with a host device connected to the connector using one of the protocols, and change said one of the protocols to another protocol to communicate with the host device upon receipt of an input operation through the button and a first signal from the sensor in a predetermined order.

### BRIEF DESCRIPTION OF THE DRAWINGS

FIG. 1 is a diagram illustrating an example of a configuration of an information processing system according to an embodiment.

FIG. 2 is a perspective view schematically illustrating an external appearance of a printer device according to the embodiment.

FIG. 3 is a diagram illustrating hardware configurations of a host device and the printer device according to the embodiment.

FIG. 4 is a schematic diagram illustrating a data configuration of a device class storage unit according to the embodiment.

FIG. 5 is a diagram illustrating a functional configuration of the printer device.

FIG. 6 is a flowchart illustrating a process performed by the printer device.

FIG. 7 is a sequence diagram illustrating operations performed between the host device and the printer device.

### DETAILED DESCRIPTION

Hereinafter, an electronic device, a method, and a storage medium according to an embodiment will be described with reference to the drawings. In the embodiment described below, a printer device is used as an example of the electronic device. However, the present disclosure is not limited to the embodiment described below.

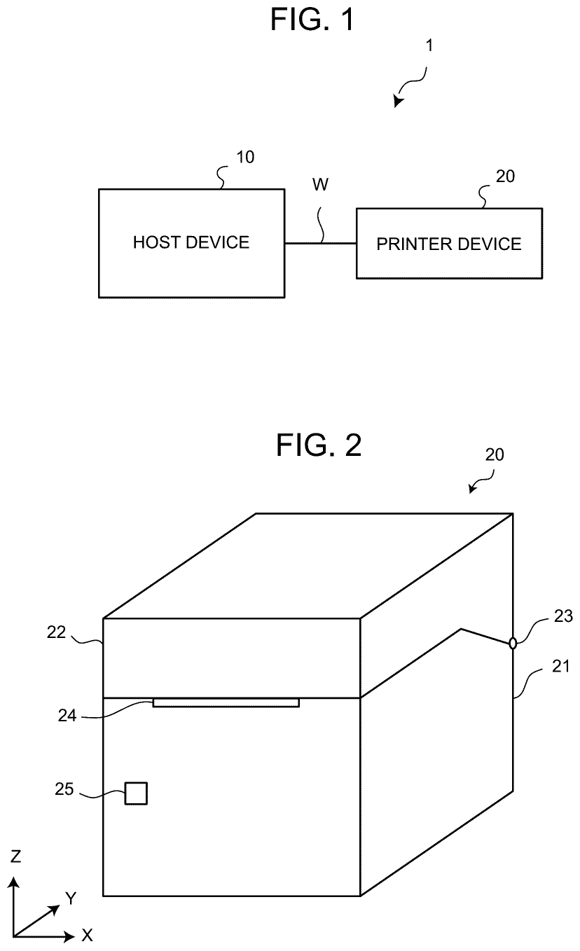

FIG. 1 is a diagram illustrating a configuration of an information processing system according to the present embodiment. As illustrated in FIG. 1, an information processing system 1 includes a host device 10 and a printer device 20.

The host device 10 is an information processing device, such as a Personal Computer (PC) or a Point-of-Sale (POS) terminal.

On the other hand, the printer device 20 is an example of an electronic device and is an example of a USB device compliant with the Universal Serial Bus (USB) standard. The printer device 20 is, for example, a thermal printer.

FIG. 2 is a perspective view schematically illustrating an external appearance of the printer device 20. In FIG. 2, the width direction, the depth direction, and the height direction of the printer device 20 are represented by three axes (X, Y, Z) that are orthogonal to each other.

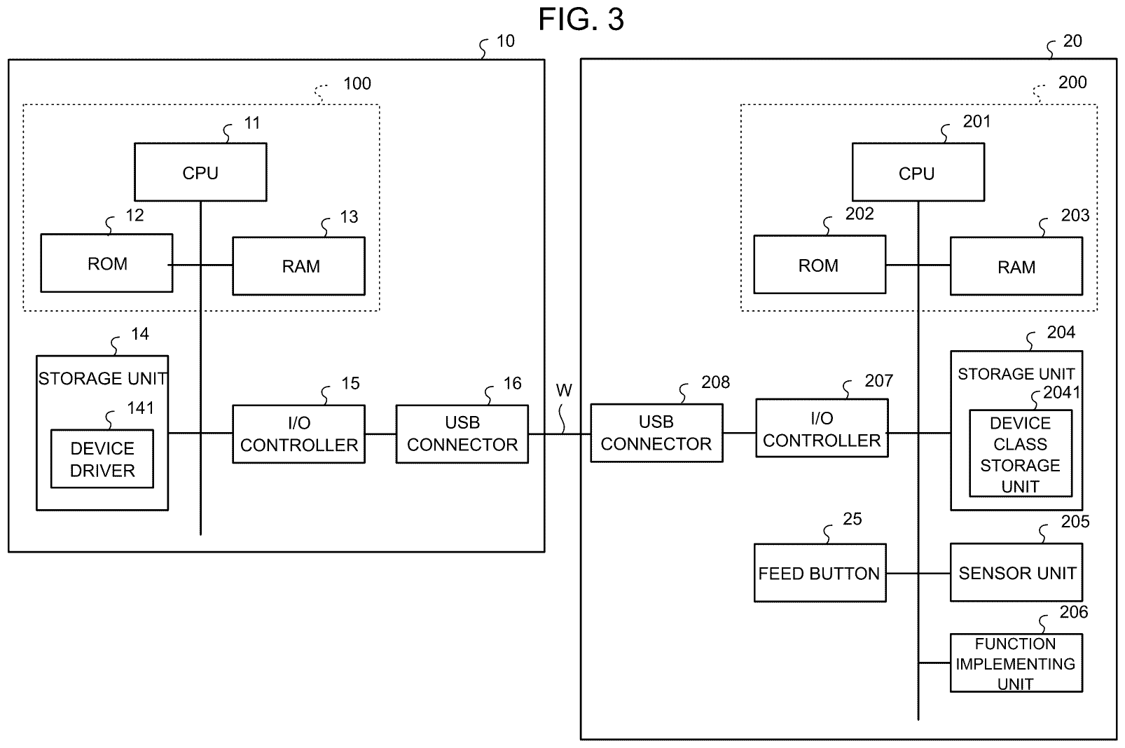

As illustrated in FIG. 2, the printer device 20 includes a box-shaped housing 21. A cover 22 is provided above the housing 21. The cover 22 is rotatable in the upward direction around a hinge 23 provided on the back side (or a +Y direction side) of the housing 21. By rotating the cover 22 upward, the inside of the housing 21 is exposed. Furthermore, a USB connector 208 (see FIG. 3), which will be described later, is provided on the back side of the housing 21.

The housing 21 houses roll paper R that is a print medium wound in a roll. In addition, the housing 21 houses a conveyance mechanism for conveying the roll paper R to a discharge port 24, which will be described later, a printing mechanism for performing printing on the roll paper R, and a control mechanism for driving and controlling components (none of which is shown) included in the printer device 20. The printing mechanism includes a platen and a thermal head and prints information, such as characters, on the roll paper R passing between the platen and the thermal head by causing the thermal head to generate heat.

The discharge port 24 is formed on the front side (or the −Y side) of the housing 21. The roll paper R, on which information is printed by the printing mechanism, is discharged from the discharge port 24. Furthermore, a feed button 25 is provided on the front side of the housing 21.

The feed button 25 is an example of an operation interface that is provided in the printer device 20 and receives a user operation. The feed button 25 is mainly used to instruct the printer device 20 to feed the roll paper R in the conveyance direction. When the printer device 20 receives an operation of pressing the feed button 25 in a state in which the cover 22 is closed, the printer device 20 controls the conveyance mechanism to convey the roll paper R toward the discharge port 24 by a length corresponding to the time for which the feed button 25 is pressed.

As described above, the printer device 20 according to the present embodiment has a simple configuration in which operation interfaces other than the feed button 25 are omitted for the purpose of compactness, cost reduction, and the like.

The printer device 20 is connected to the host device 10 via a USB cable W (see FIG. 1). When the printer device 20 is connected to the host device 10, a process, which is called enumeration, is executed to establish communication with the printer device 20. When the enumeration is completed successfully, the host device 10 becomes ready to use the printer device 20.

Note that the configuration of the printer device 20 is not limited to that illustrated in FIG. 2. For example, the printer device 20 may include an indicator, such as an indicator lamp, for notifying an operation state of the printer device 20.

Next, hardware configurations of the host device 10 and the printer device 20 will be described. FIG. 3 is a diagram illustrating examples of hardware configurations of the host device 10 and the printer device 20.

As illustrated in FIG. 3, the host device 10 includes a central processing unit (CPU) 11, a read-only memory (ROM) 12, and a random access memory (RAM) 13. The CPU 11 is an example of a processor and controls the operation of the entire host device 10. The ROM 12 stores various programs. The RAM 13 is used as a working memory into which various types of data are loaded.

The CPU 11, the ROM 12, and the RAM 13 are connected to each other via a bus or the like and constitute a control unit 100. The CPU 11 operates according to programs stored in the ROM 12 and a storage unit 14 described later, and the control unit 100 thereby executes various processes.

The storage unit 14 is connected to the control unit 100 via a bus or the like. The storage unit 14 is an example of a storage device and implemented by a nonvolatile memory, such as a Hard Disk Drive (HDD) or a Solid State Drive (SSD), that retains stored data even when the power is turned off.

The storage unit 14 stores an Operating System (OS), various programs, setting information, and the like. The storage unit 14 also stores a device driver 141. The device driver 141 is software (or a program) for controlling a USB device corresponding to a particular device class. The device class will be described later.

The device driver 141 may be a standard device driver that is incorporated in the OS. The device driver 141 may be a vendor-specific device driver (hereinafter, also referred to as a vendor driver) provided from a vendor of a USB device.

The device driver 141 may correspond to any appropriate device class. Examples of device classes may include a Mass Storage Class (MSC), an image (scanner) class, a printer class, and a vendor-specific device class. Also, both of a standard driver and a vendor driver may be installed as device drivers 141 for the same USB device. In this case, different device classes (or class codes) are assigned to the standard driver and the vendor driver, and one of them (for example, the vendor driver) is used preferentially.

An I/O controller 15 including a USB controller is connected to the control unit 100 via a bus or the like. A USB connector 16 is connected to the I/O controller 15. The I/O controller 15 controls the transmission and reception of signals via the USB connector 16.

On the other hand, as shown in FIG. 3, the printer device 20 includes a CPU 201, a ROM 202 and a RAM 203. The CPU 201 is an example of a processor and controls the operation of the entire printer device 20. The ROM 202 stores various programs. The RAM 203 is used as a working memory into which various types of data are loaded.

The CPU 201, the ROM 202, and the RAM 203 are connected to each other via a bus or the like and constitute a control unit 200. The control unit 200 is an example of a processor. The CPU 201 operates in accordance with programs stored in the ROM 202 and a storage unit 204 described later, and the control unit 200 thereby executes various processes, such as enumeration with the host device 10.

The storage unit 204, a sensor unit 205, a function implementing unit 206, and the like are connected to the control unit 200 via a bus or the like. The storage unit 204 is implemented by a nonvolatile memory, such as a flash memory, that retains stored information even when the power is turned off.

The storage unit 204 stores an embedded OS, various programs, setting information, and the like. For example, the storage unit 204 stores setting information for setting a device class that is read from a device class storage unit 2041 described later when the printer device 20 is activated. The storage unit 204 also includes the device class storage unit 2041 that stores multiple device classes that can be used by the printer device 20.

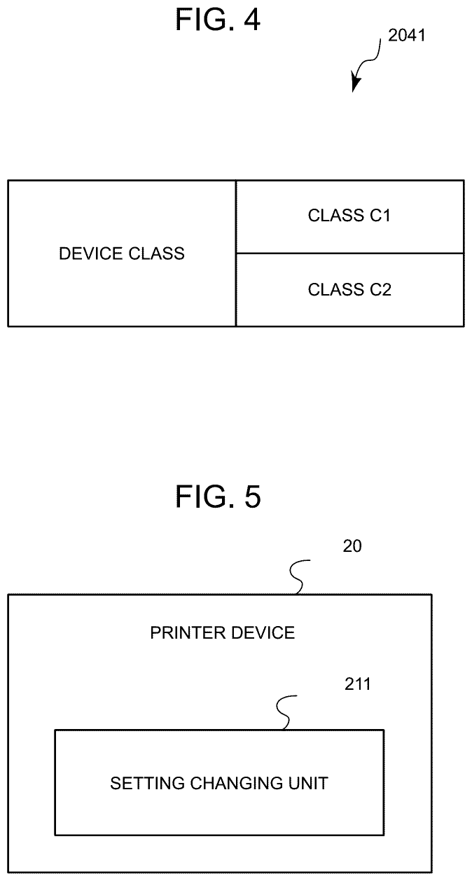

FIG. 4 is a schematic diagram illustrating a data configuration of the device class storage unit 2041. As illustrated in FIG. 4, the device class storage unit 2041 stores multiple device classes that can be used by the printer device 30. Here, each device class indicates the type of USB devices that have similar features and functions. More specifically, the device classes are programs, such as firmware and device drivers, that define specifications of respective types of USB devices and protocols used to establish communication with the host device 10.

The device class storage unit 2041 illustrated in FIG. 4 stores two device classes: a class C1 and a class C2. Here, the class C1 is, for example, a device class corresponding to a vendor driver of a vendor that manufactures the printer device 20, and the class C2 is a device class corresponding to a standard driver.

The number of device classes stored in the device class storage unit 2041 is not limited to the example shown in FIG. 4 and may be three or more. In addition, the device class storage unit 2041 may store identifiers, such as flags, indicating a device class to be used in the initial state and a device class currently in use (or a current device class) in association with the device classes and may also store priority levels in association with the device classes.

Returning to FIG. 3, the sensor unit 205 is an example of a detector. The sensor unit 205 may correspond to various sensor devices included in the printer device 20. Specifically, the sensor unit 205 includes an open/close sensor that detects the open state and the closed state of the cover 22. The open/close sensor detects the open state or the closed state of the cover 22, and outputs the detection result to the CPU 201. That is, the open/close sensor detects operations on the printer device 20 other than the operation performed via the feed button 25.

Here, when the open/close sensor detects the open state of the cover 22, the conveyance of the roll paper R and printing are prohibited. In other words, the open/close sensor can detect a structural change (e.g., the open state of the cover 22) of the printer device 20 that hinders the conveyance of the roll paper R performed when the feed button 25 is operated. Note that the method of detecting the open/closed state of the cover 22 is not limited to the example described above. As another example, a microswitch, a magnetic sensor, or the like may be used.

The sensor unit 205 may also include other sensor devices in addition to the open/close sensor. For example, the sensor unit 205 may include a sensor device that detects whether the roll paper R is attached to the housing 21, a sensor device that identifies the type of the roll paper R, and the like. Furthermore, the sensor unit 205 may include a near-end sensor for detecting the end or the near-end of the roll paper R, a temperature sensor for detecting the temperature of the thermal head, and the like.

The function implementing unit 206 includes hardware components for implementing functions of the printer device 20. For example, when the printer device 20 is a thermal printer, the function implementing unit 206 corresponds to the thermal head, the printing mechanism for controlling the thermal head, the conveyance mechanism for conveying a print medium, and the like.

In addition to the feed button 25, an I/O controller 207 including a USB controller is connected to the control unit 200 via a bus or the like. The I/O controller 207 is connected to a USB connector 208 that is an example of a connector. The I/O controller 207 controls transmission and reception of signals via the USB connector 208.

As shown in FIG. 3, the host device 10 and the printer device 20 are electrically connected to each other by connecting the USB connector 16 of the host device 10 to the USB connector 208 of the printer device 20 via the USB cable W. When the printer device 20 is electrically connected to the host device 10 via the USB cable W, the host device 10 starts enumeration to establish communication with the printer device 20.

Specifically, when the printer device 20 is connected to the host device 10, the control unit 100 of the host device 10 acquires a class code indicating the device class from the printer device 20 via the I/O controller 15, and thereby determines the device class of the connected printer device 20. When the device class of the printer device 20 matches the device class of the device driver 141 installed in the host device 10, the control unit 100 determines that the printer device 20 has been recognized. In this case, the control unit 100 cooperates with the device driver 141 to transmit a message, such as a command that conforms to the device class of the printer device 20, to the printer device 20 and thereby establishes communication with the printer device 20. As a result, the host device 10 is enabled to use the printer device 20 connected to the USB connector 16 as a peripheral device.

On the other hand, when the device class of the printer device 20 does not match the device class of the device driver 141, the control unit 100 determines that the printer device 20 cannot be recognized and stops (ends) enumeration. When the enumeration is stopped, that is, when the enumeration fails, the host device 10 cannot control the printer device 20 and therefore cannot use the printer device 20 as a peripheral device.

When communication with the host device 10 cannot be established due to the mismatch of device classes, the printer device 20 may be operated using a desired device class by selecting the device class from among the multiple device classes included in the printer device 20. However, when a printer device has a simple configuration including a minimum number of operation interfaces, the device class cannot be easily changed. For example, when a printer device has a simple configuration, it is necessary to connect a computer to the printer device and transmit a command from the computer to the printer device to change the device class.

In view of the above problem, the printer device 20 of the present embodiment has a function that makes it possible to easily change the device class. Next, a functional configuration of the printer device 20 will be described with reference to FIG. 5.

FIG. 5 is a diagram illustrating an example of a functional configuration of the printer device 20. As illustrated in FIG. 5, the printer device 20 includes a setting changing unit 211 as a functional unit.

The setting changing unit 211 may be a software component implemented by the processor (for example, the CPU 201 or the control unit 200) of the printer device 20 by executing a program stored in a memory (for example, the ROM 202 or the storage unit 204). Alternatively, the setting changing unit 211 may be a hardware component implemented by a dedicated circuit included in the printer device 20.

The setting changing unit 211 is an example of a changing unit, an output unit, and a restart unit. The setting changing unit 211 performs a process of changing a device class currently in use (which may also be referred to as a current device class) to another device class in response to a user operation. Specifically, when the setting changing unit 211 detects, in cooperation with the sensor unit 205, a predetermined operation (hereinafter also referred to as a combination operation) that is a combination of the operation of the feed button 25 and another operation, the setting changing unit 211 performs a process of changing the current device class to another device class.

For example, when detecting that the feed button 25 has been pressed for a predetermined time (for example, 3 seconds) or longer after the cover 22 is opened, the setting changing unit 211 determines that an instruction to change the device class is received. In this case, the setting changing unit 211 changes the setting such that one of device classes stored in the device class storage unit 2041 and different from the current device class is used at the next startup.

Here, when multiple device classes other than the current device class are stored in the device class storage unit 2041, the setting changing unit 211 changes the setting such that one of the other device classes is used at the next startup. For example, the setting changing unit 211 may randomly select a device class to be used at the next startup. When the priority levels are set to the device classes, the setting changing unit 211 may select the device class to be used at the next startup based on the priority levels.

When detecting that the cover 22 is in the closed state after changing the device class to be used, the setting changing unit 211 controls the conveyance mechanism and the printing mechanism to print information including the changed device class. For example, the setting changing unit 211 causes the printing mechanism to print information (such as a device class name) for identifying the changed device class on the roll paper R, and causes the conveyance mechanism to discharge a portion of the roll paper R on which the information is printed from the discharge port 24.

Thus, the user can confirm the changed device class by viewing the information printed on the portion of the roll paper R discharged from the discharge port 24. Therefore, even when the printer device 20 has a simple configuration including no display device, the user can easily confirm the changed device class, and the user convenience is improved.

When the cover 22 is opened again and the feed button 25 is pressed for a predetermined time or longer after the information including the changed device class is printed, the setting changing unit 211 changes the device class again. Also, when the feed button 25 is pressed again for a predetermined time or longer after the pressing of the feed button 25 is stopped while the cover 22 is in the open state, the setting changing unit 211 changes the device class again.

Furthermore, the information printed and output by the setting changing unit 211 after changing the device class may also include items other than the changed device class. For example, the setting changing unit 211 may print and output the changed device class and the original device class (or the device class before being changed) so that they can be compared with each other. This enables the user to confirm the original and changed device classes by viewing the printed information discharged from the discharge port 24 and thereby makes it possible to improve the user convenience.

After changing the device class, the setting changing unit 211 restarts the printer device 20 to cause the printer device 20 to operate using the changed device class. For example, the setting changing unit 211 prints the information including the changed device class and then restarts the printer device 20.

As a result, the printer device 20 becomes ready to use the changed device class. Specifically, the control unit 200 of the printer device 20 performs enumeration with the host device 10 connected to the USB connector 208 using the changed device class. In the enumeration, the control unit 200 transmits a class code indicating the changed device class to the host device 10 in response to a request from the host device 10. Then, when a message conforming to the changed device class is transmitted from the host device 10, the setting changing unit 211 establishes communication with the host device 10 based on the protocol defined in the device class. Thereafter, the printer device 20 operates as a peripheral device of the host device 10.

The setting changing unit 211 may be configured not to print information indicating the changed device class. In this case, the setting changing unit 211 may restart the printer device 20 when the closed state of the cover 22 is detected.

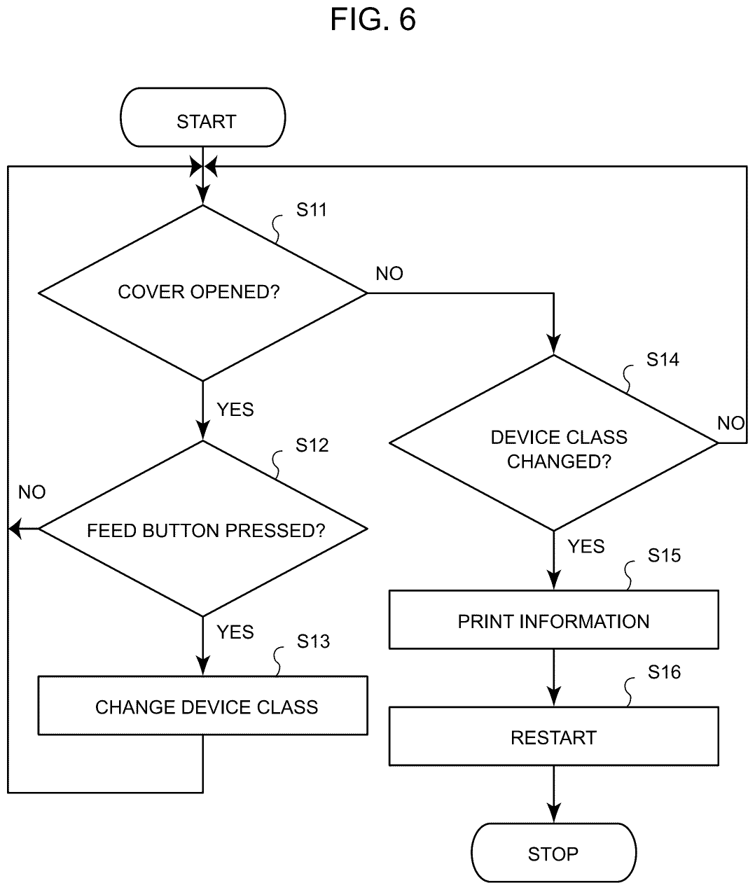

Next, operations of the printer device 20 will be described. FIG. 6 is a flowchart illustrating a process executed by the printer device 20. FIG. 6 illustrates an example of a process related to the changing of the device class. The processor (or the control unit 200) of the printer device 20 may be configured to perform the steps of the process described below. That is, the setting changing unit 211 in the descriptions below may be replaced with the processor.

First, the setting changing unit 211 determines whether the cover 22 has been opened based on the detection result of the sensor unit 205 (step S11). When determining that the cover 22 has been opened (step S11: Yes), the setting changing unit 211 determines whether the feed button 25 has been pressed for a predetermined time or longer (step S12).

When determining that the feed button 25 has not been pressed for the predetermined time or longer (step S12: No), the setting changing unit 211 returns the process to step S11. When determining that the feed button 25 has been pressed for the predetermined time or longer (step S12: Yes), the setting changing unit 211 changes the setting so that a device class other than the current device class is used at the next startup (step S13), and returns the process to step S11. In order to record that the device class has been changed, the setting changing unit 211 may store, in, for example, the RAM 203, flag information (hereinafter also referred to as a setting change flag) indicating that the device class has been changed.

On the other hand, when the setting changing unit 211 determines, at step S11, that the cover 22 is closed (step S11: No), the process proceeds to step S14.

At step S14, the setting changing unit 211 determines whether the device class has been changed, that is, whether step S13 has been performed. For example, the setting changing unit 211 determines whether the device class has been changed based on the presence or absence of the setting change flag.

When the device class has not been changed (step S14: No), the setting changing unit 211 returns the process to step S11. When the feed button 25 is pressed during the loop of step S11 (No) to step S14 (No), the control unit 200 performs a process of conveying the roll paper R in the conveying direction. In addition, during the loop of step S11 (No) to step S14 (No), printing is performed on the roll paper R.

When determining that the device class has been changed (step S14: Yes), the setting changing unit 211 prints information including the changed device class (step S15). Then, the setting changing unit 211 restarts the printer device 20 (step S16) and ends the process.

Through the above process, the printer device 20 changes the device class used in the printer device 20 in response to a user operation. Then, the printer device 20 performs enumeration with the host device 10 using the changed device class.

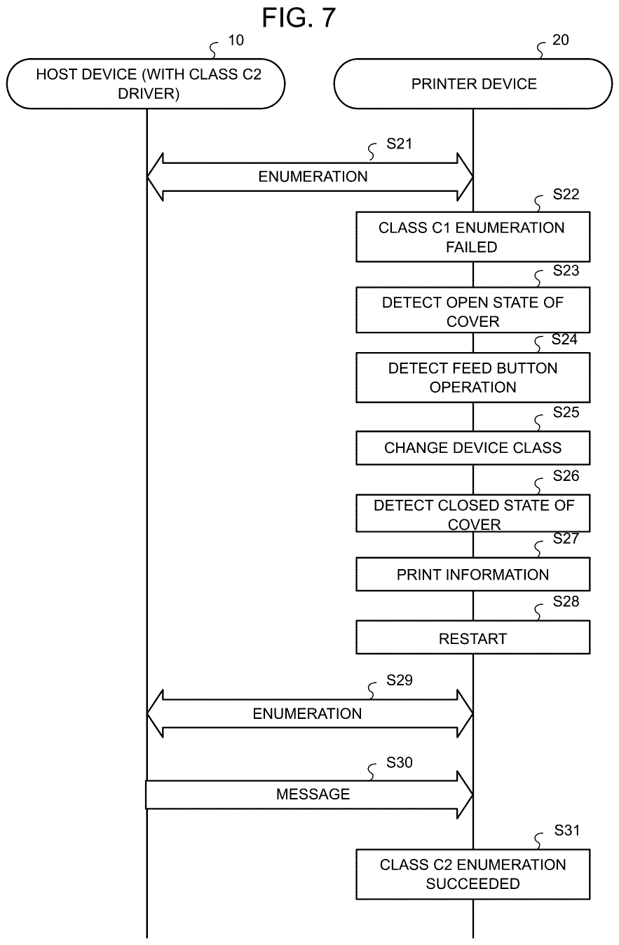

Next, examples of operations performed between the host device 10 and the printer device 20 will be described with reference to FIG. 7. FIG. 7 is a sequence diagram illustrating examples of operations performed between the host device 10 and the printer device 20.

In FIG. 7, it is assumed that the printer device 20 supports device classes “class C1” and “class C2” shown in FIG. 4 and is set to use “class C1” in the initial state. Also, it is assumed that the device driver 141 corresponding to “class C2” is installed in the host device 10.

When the printer device 20 is connected to the host device 10 and receives a request from the host device 10, the control unit 200 (or the processor) of the printer device 20 starts enumeration by, for example, transmitting a class code indicating “class C1” to the host device 10 (step S21).

In this case, the host device 10 determines that the class code “class C1” acquired from the printer device 20 does not match the device driver 141 installed in the host device 10 and determines that the printer device 20 is an unknown device that cannot be handled by the host device 10. Therefore, the host device 10 ends the enumeration without transmitting a message conforming to “class C1” to the printer device 20.

On the other hand, the control unit 200 of the printer device 20 waits for a message from the host device 10 after the enumeration is started at step S21. However, because the host device 10 has determined that the printer device 20 is an unknown device, communication with the host device 10 cannot be established. Therefore, the control unit 200 of the printer device 20 determines that the enumeration has failed (step S22). For example, the control unit 200 determines that the enumeration has failed when no message is received from the host device 10 within a waiting period after the enumeration is started.

When the enumeration fails, the control unit 200 may control the conveyance mechanism and the printing mechanism to print information indicating the failure of the enumeration. Also, when the printer device 20 includes an indicator, such as an indicator lamp, the control unit 200 may notify the failure of the enumeration via the indicator.

When the enumeration fails, in order to change the device class of the printer device 20, the user opens the cover 22 and presses the feed button 25 for a predetermined time or longer as described above.

When determining that the cover 22 has been opened (step S23) and that the feed button 25 has been pressed for the predetermined time or longer (step S24), the setting changing unit 211 of the printer device 20 changes the current device class “class C1” to “class C2” (step S25).

Next, when the setting changing unit 211 of the printer device 20 determines that the cover 22 has been closed (step S26), information including the changed device class is printed (step S27). Then, the setting changing unit 211 restarts the printer device 20 (step S28).

After the printer device 20 is restarted, the host device 10 and the printer device 20 are reconnected to each other. After the reconnection, the control unit 200 of the printer device 20 transmits a class code indicating the changed device class “class C2” to the host device 10 in response to a request from the host device 10, and starts enumeration (step S29).

In this case, the host device 10 determines that the class code “class C2” acquired from the printer device 20 matches the device driver 141 installed in the host device 10 and transmits a message conforming to “class C2” to the printer device 20 (step S30).

The control unit 200 of the printer device 20 waits for a message from the host device 10 after the enumeration is started at step S29. When a message is received within the waiting period, the control unit 200 of the printer device 20 determines that the enumeration has been successfully completed (step S31). In this case, communication between the host device 10 and the printer device 20 is established, and the host device 10 can perform printing using the printer device 20.

Thus, with the printer device 20, even when the current device class does not match the protocol (that is, the device driver 141) of the host device 10, the device class can be changed to match the protocol of the host device 10.

As described above, the printer device 20 of the present embodiment includes the USB connector 208 connectable to the host device 10, the feed button 25 that receives an operation from the user, the sensor unit 205 that detects an operation on the printer device 20 other than the operation performed using the feed button 25, the device class storage unit 2041 that stores multiple device classes indicating protocols for establishing communication, the control unit 200 that executes a process of establishing communication with the host device 10 connected to the USB connector 208 by using one of the device classes stored in the device class storage unit 2041, and the setting changing unit 211 that changes the device class used by the control unit 200 for the process in response to a combination of the operation performed using the feed button 25 and the operation detected by the sensor unit 205.

Thus, the printer device 20 can change the device class in response to a combination of the operation performed using the feed button 25 and the opening operation of the cover 22. Therefore, even with the printer device 20 having a simple configuration in which only the feed button 25 is provided as an operation interface, the user can easily change the device class, and the user convenience in changing the device class can be improved.

The above-described embodiment may be appropriately modified and implemented by changing some of the configurations or functions of the printer device 20. Below, variations of the above-described embodiment will be described as other embodiments. Below, differences from the above-described embodiment will be mainly described, and detailed descriptions of features that are the same as those described above will be omitted. Furthermore, the variations described below may be implemented individually or in combination as appropriate.

### (First Variation)

Although the above-described embodiment is described using the printer device 20, the above-described embodiment may also be applied to any other type of electronic device, such as a scanner device, a cash register, an automatic change machine, or the like.

### (Second Variation)

In the above-described embodiment, the device class is changed in response to a combination of an operation of opening the cover 22 and an operation of pressing the feed button 25 for a predetermined time or longer. However, the combination of operations for changing the device class is not limited to this example.

For example, the setting changing unit 211 may be configured to change the device class when determining that the roll paper R has been taken out from the housing 21 based on a detection result of a sensor device that detects whether the roll paper R is placed in the housing 21 and also determining that the feed button 25 has been pressed for a predetermined time or longer. In this case, after changing the device class, the setting changing unit 211 prints information including the changed device class and restarts the printer device 20 upon determining that the roll paper R is placed in the housing 21 and the cover 22 is closed.

Furthermore, the combination operation may be appropriately changed according to the type and configuration of the electronic device. For example, in a printer device that prints information on a sheet of paper, an opening or closing operation of a tray storing sheets of paper may be a part of the combination operation.

### (Third Variation)

In the above-described embodiment, the setting changing unit 211 is configured to change the device class in response to user operations. However, the present disclosure is not limited to this example, and the setting changing unit 211 may be configured to automatically change the device class.

For example, the setting changing unit 211 may be configured to automatically change the device class when no message is transmitted from the host device 10 within a predetermined time after enumeration with the host device 10 is started. In this case, the setting changing unit 211 may be configured to print information including the changed device class or may be configured to restart the printer device 20 without printing the information.

Thus, the printer device 20 may be configured to attempt enumeration with the host device 10 while automatically changing the device class until the changed device class matches the protocol (or the device driver 141) of the host device 10. With this configuration, the printer device 20 can automatically change the device class in accordance with the protocol of the host device 10.

Furthermore, the printer device 20 (or the setting changing unit 211) may be configured to switch between manual and automatic modes for changing the device class according to whether the host device 10 is connected to the printer device 20. Specifically, when the host device 10 is connected to the printer device 20, the setting changing unit 211 automatically changes the device class based on whether the message is transmitted from the host device 10 after enumeration with the host device 10 is started. On the other hand, when the host device 10 is not connected to the printer device 20, the setting changing unit 211 changes the device class in response to the combination operation as described in the above embodiment.

As described above, the printer device 20 may be configured to switch between the manual and automatic modes for changing the device class according to the connection state of the host device 10. This makes it possible to further improve the convenience of the user.

Programs to be executed by the devices of the above-described embodiments may be provided in a ROM or the like in advance. Also, programs to be executed by the devices of the above-described embodiments may be provided in a non-transitory computer-readable storage medium, such as a CD-ROM, a flexible disk (FD), a CD-R, or a Digital Versatile Disk (DVD), in an installable format or an executable format.

Also, programs to be executed by the devices of the above-described embodiments may be stored in a computer connected to a network, such as the Internet, and may be downloaded via the network. Furthermore, programs to be executed by the devices of the above-described embodiments may be provided or distributed via a network, such as the Internet.

While certain embodiments have been described, these embodiments have been presented by way of example only, and are not intended to limit the scope of the disclosure. Indeed, the novel embodiments described herein may be embodied in a variety of other forms; furthermore, various omissions, substitutions and changes in the form of the embodiments described herein may be made without departing from the spirit of the disclosure. The accompanying claims and their equivalents are intended to cover such forms or modifications as would fall within the scope and spirit of the disclosure.

What is claimed is:

1. An electronic device connectable to a host device, the electronic device comprising:
a housing including a cover;
a connector;
a button on an outer surface of the housing;
a sensor attached to the cover;
a storage device that stores first information indicating a plurality of protocols each for establishing communication with a device of a different device class; and
a processor configured to:
perform a process of establishing communication with a host device connected to the connector using one of the protocols, and
change said one of the protocols to another protocol to communicate with the host device upon receipt of an input operation through the button and a first signal from the sensor in a predetermined order.

2. The electronic device according to claim 1, wherein
the sensor outputs the first signal when the cover is opened.

3. The electronic device according to claim 2, wherein
the electronic device is a printer configured to print on a print medium, and
the processor is configured to:
perform a process of feeding the print medium when the input operation is received through the button, and
change said one of the protocols to another protocol when the input operation is received for a predetermined time or longer after the first signal is received from the sensor.

4. The electronic device according to claim 3, wherein
the sensor outputs a second signal when the cover is closed, and
the processor is configured to perform a process of printing second information indicating said another protocol upon receipt of the second signal after said one of the protocols is changed to another protocol.

5. The electronic device according to claim 4, wherein
the second information further indicates said one of the protocols.

6. The electronic device according to claim 1, wherein
the processor is configured to restart the electronic device after said one of the protocols is changed to another protocol.

7. The electronic device according to claim 6, wherein
after the electronic device is restarted, the processor causes the connector to transmit a class code corresponding to said another protocol to the host device in response to a request from the host device and thereby start a process of establishing communication with the host device using said another protocol.

8. The electronic device according to claim 7, wherein
the processor is configured to determine that the process of establishing communication has been successfully completed when a message is received from the host device within a waiting period after the process of establishing communication is started.

9. The electronic device according to claim 1, wherein
the protocols are associated with priority levels by the first information, and
the processor is configured to select another protocol based on the priority levels.

10. The electronic device according to claim 1, wherein
the processor is configured to select another protocol randomly.

11. A method performed by an electronic device connectable to a host device and including:
a housing including a cover,
a connector,
a button on an outer surface of the housing, and
a sensor attached to the cover, the method comprising:
storing, in a storage device, first information indicating a plurality of protocols each for establishing communication with a device of a different device class;
performing a process of establishing communication with a host device connected to the connector using one of the protocols; and
changing said one of the protocols to another protocol to communicate with the host device upon receipt of an input operation through the button and a first signal from the sensor in a predetermined order.

12. The method according to claim 11, wherein
the sensor outputs the first signal when the cover is opened.

13. The method according to claim 12, wherein
the electronic device is a printer configured to print on a print medium,
the method further comprises:
performing a process of feeding the print medium when the input operation is received through the button, and
said one of the protocols is changed to another protocol when the input operation is received for a predetermined time or longer after the first signal is received from the sensor.

14. The method according to claim 13, wherein
the sensor outputs a second signal when the cover is closed, and
the method further comprises:
performing a process of printing second information indicating said another protocol upon receipt of the second signal after said one of the protocols is changed to another protocol.

15. The method according to claim 14, wherein
the second information further indicates said one of the protocols.

16. The method according to claim 11, further comprising:
restarting the electronic device after said one of the protocols is changed to another protocol.

17. The method according to claim 16, further comprising:
after the electronic device is restarted, transmitting a class code corresponding to said another protocol to the host device in response to a request from the host device and thereby starting a process of establishing communication with the host device using said another protocol.

18. The method according to claim 17, further comprising:
determining that the process of establishing communication has been successfully completed when a message is received from the host device within a waiting period after the process of establishing communication is started.

19. The method according to claim 11, wherein
the protocols are associated with priority levels by the first information, and
the method further comprises:
selecting another protocol based on the priority levels.

20. A non-transitory computer-readable storage medium storing a program for causing a processor of an electronic device to perform a process, the electronic device including:
a housing including a cover,
a connector,
a button on an outer surface of the housing, and
a sensor attached to the cover, and
the process comprising:
storing, in a storage device, first information indicating a plurality of protocols each for establishing communication with a device of a different device class;
performing a process of establishing communication with a host device connected to the connector using one of the protocols; and
changing said one of the protocols to another protocol to communicate with the host device upon receipt of an input operation through the button and a first signal from the sensor in a predetermined order.
